(19) United States
(12) Patent Application Publication
(10) Pub. No.: US 2025/0296476 A1
(43) Pub. Date: Sep. 25, 2025

(54) VEHICLE

(71) Applicant: TOYOTA JIDOSHA KABUSHIKI KAISHA, Toyota-shi (JP)

(72) Inventor: Keiichi MINAMIURA, Nagoya-shi (JP)

(73) Assignee: TOYOTA JIDOSHA KABUSHIKI KAISHA, Toyota-shi (JP)

(21) Appl. No.: 19/059,534

(22) Filed: Feb. 21, 2025

(30) Foreign Application Priority Data
Mar. 22, 2024 (JP) 2024-046171

(51) Int. Cl. B60L 58/24

(52) U.S. Cl. CPC B60L 58/24; B60L 2240/545; B60L 2250/16; B60L 2260/22

(57) ABSTRACT

An ECU executes a process including: acquiring a battery temperature and a target temperature during parking; operating a cooling device when it is determined that the battery temperature is equal to or higher than a target temperature ±α; executing a first display process; operating a heating device when it is determined that the battery temperature is equal to or lower than the target temperature −β; and executing a second display process.

### CROSS REFERENCE TO RELATED APPLICATIONS

This nonprovisional application is based on Japanese Patent Application No. 2024-046171 filed on Mar. 22, 2024 with the Japan Patent Office, the entire contents of which are hereby incorporated by reference.

### BACKGROUND

### Field

The present disclosure relates to a vehicle.

### Description of the Background Art

Japanese Patent Laying-Open No. 2009-044887 discloses a technique in which, when a destination is a chargeable place, the temperature of the power storage device is adjusted by heating or cooling the power storage device so that the temperature of the power storage device reaches a temperature at which charging efficiency is high when the power storage device arrives at the destination.

### SUMMARY

However, since an operation sound may be generated when an electric device used for heating or cooling is operated to adjust the temperature of the power storage device, a user who cannot recognize a cause of the operation sound may feel a sense of discomfort.

An object of the present disclosure is to provide a vehicle that displays a state of temperature adjustment of a power storage device so as to allow a user to recognize the state of temperature adjustment.

A vehicle according to an aspect of the present disclosure includes: a power storage device that supplies power to a drive source; an adjustment device that adjusts a temperature of the power storage device so as to reach a target temperature; and a display device that displays predetermined information. During an operation of the adjustment device, the display device displays operation information indicating (i) a state of deviation between the temperature of the power storage device and the target temperature, and (ii) an operation state of the adjustment device.

In this way, the user can recognize the cause of the operation of the adjustment device. Therefore, it is possible to suppress the user from feeling a sense of discomfort even when the adjustment device is operated.

In an embodiment, the display device displays the operation information during parking of the vehicle and during an operation of the adjustment device.

In this way, it is possible to allow the user to recognize the cause of the operation of the adjustment device during the parking in which generation of the operation sound is likely to be recognized.

Further, in an embodiment, the display device displays the operation state during the parking of the vehicle and during the operation of the adjustment device, when a terminal that is able to unlock the vehicle is detected to approach the vehicle.

In this way, it is possible to suppress the user having approached the vehicle from feeling a sense of discomfort about the operation of the adjustment device.

Further, in an embodiment, the adjustment device adjusts the temperature of the power storage device using the power of the power storage device or power of an external power supply.

In this way, the user can recognize the cause of the operation of the adjustment device that operates using power.

Further, in an embodiment, the display device displays the state of deviation using a band graph or a circular graph.

In this way, since the state of deviation is displayed to the user in the form of a band graph, it is possible to suppress the user from feeling a sense of discomfort about the operation of the adjustment device.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an example of a configuration of a power transmission system.

FIG. 2 is a flowchart showing an example of processing executed by an ECU.

FIG. 3 is a diagram illustrating an example of a display screen displayed on a display device.

FIG. 4 is a diagram showing another example of a display screen displayed on the display device.

FIG. 5 is a flowchart illustrating an example of processing executed by an ECU according to a modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

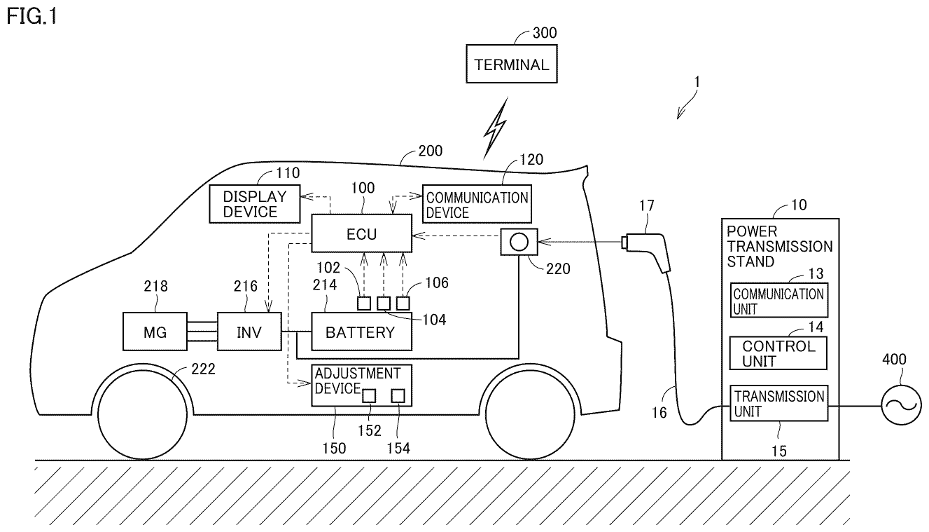

Hereinafter, an example of the configuration of the power transmission system 1 according to the present embodiment will be described. FIG. 1 is a diagram illustrating an example of a configuration of a power transmission system 1. As illustrated in FIG. 1, the power transmission system 1 includes a vehicle 200, a power transmission stand 10 outside the vehicle 200, and a terminal 300. The vehicle 200 may be a vehicle capable of transmitting power to an external facility, and is, for example, an electrically powered vehicle such as a battery electric vehicle or a plug-in hybrid electric vehicle.

Vehicle 200 includes ECU (Electronic Control Unit) 100, which is a control device, display device 110, communication device 120, adjustment device 150, battery (power storage device) 214, inverter 216, MG (Motor Generator) 218, and inlet 220.

The battery 214 may be a rechargeable power storage device, and may be, for example, a secondary battery such as a nickel-metal hydride battery or a lithium ion battery having a liquid or solid electrolyte, or a large-capacity capacitor or the like may be used instead of the battery 214.

Inverter 216 is configured to be capable of bidirectionally converting DC power of battery 214 and AC power of MG 218 in response to a control signal from ECU 100.

The MG 218 is a drive source that drives the drive wheels 222 of the vehicle 200, and is configured by a three-phase AC rotary electric machine or the like. MG 218 has a function as an electric motor (motor) that causes vehicle 200 to travel using power of battery 214, and a function as a generator that generates power (for example, regenerative power) for charging battery 214.

The inlet 220 has a shape to which the connector 17 of the power transmission stand 10 can be attached. The inlet 220 is electrically connected to the battery 214.

Sensors 102, 104, and 106 for acquiring the voltage, current, and temperature of the battery 214 are connected to the ECU 100. The ECU 100 includes a CPU (Central Processing Unit) and a memory (both not shown). ECU 100 controls each device such that vehicle 200 is in a desired state based on signals received from each sensor and information such as a map and a program stored in a memory.

The ECU 100 has a function of sequentially calculating a state of charge (SOC) of the battery 214 based on the detection values of the sensors 102, 104, and 106. As a method of calculating the SOC, for example, various known methods such as a method based on current value integration (coulomb count) or a method based on estimation of an open circuit voltage (OCV) can be employed. The ECU 100 is configured to communicate with a communication unit 13 of the power transmission stand 10, which will be described later.

The display device 110 is configured by, for example, a display unit of a touch panel display provided around the driver's seat. The display unit is configured by, for example, an LCD (Liquid Crystal Display), an organic EL (Electro-Luminescence), or the like.

The communication device 120 is configured to be capable of communicating between the ECU 100 and a terminal 300 outside the vehicle 200. The communication device 120 is configured by, for example, one or more antennas provided in the vehicle 200. The communication device 120 is configured to transmit, for example, information from the ECU 100 to the terminal 300. The communication device 120 may be configured to receive information from the terminal 300 and transmit the information to the ECU 100.

The adjustment device 150 is configured to adjust the temperature of the battery 214 in accordance with a control signal from the ECU 100. The adjustment device 150 includes a heating device 152 that heats the battery 214 and a cooling device 154 that cools the battery 214. The heating device 152 may be configured by, for example, an electric heater. The cooling device 154 may be configured by, for example, a cooling fan. The cooling device 154 may include, for example, a heat exchangeable radiator, a medium (for example, a coolant or a gas), a pump that pumps the medium, and a cooling passage through which the medium flows.

When raising the temperature of the battery 214, the ECU 100 operates the heating device 152 while stopping the cooling device 154. For example, the ECU 100 activates the heating device 152 when the temperature of the battery 214 is lower than a predetermined temperature range including the target temperature.

When lowering the temperature of the battery 214, the ECU 100 operates the cooling device 154 while stopping the heating device 152. Each of the heating device 152 and the cooling device 154 is configured to be operable using, for example, power supplied from the vehicle 200 to the inlet 220 (power of an external power supply) and/or power supplied from the battery 214.

Further, the ECU 100 controls a door lock device (not shown). For example, in a case where communication with a device (for example, the terminal 300) for requesting locking or unlocking of a door lock from the outside of the vehicle 200 is enabled via the communication device 120, the ECU 100 controls the door lock device so as to be in a state according to the command when receiving a locking command or a unlocking command of the door lock from the device. For example, the ECU 100 controls the door lock device so that the door lock (locking) is unlocked when the unlocking command is received. Further, for example, the ECU 100 controls the door lock device so as to lock the door when receiving the locking command.

ECU 100 can detect the position of terminal 300 using information received from terminal 300. The ECU 100 detects the approach of the terminal 300 to the vehicle 200 according to the reception intensity of the signal from the terminal 300 at the antenna of the communication device 120. For example, ECU 100 can detect that terminal 300 has approached vehicle 200 within a predetermined distance by being able to communicate with terminal 300. The ECU 100 may unlock the door lock device when the approach of the terminal 300 is detected when the door lock device is in the locked state.

The communication device 120 may include a plurality of antennas. The ECU 100 may detect approaching to the vehicle 200 when the position of the terminal 300 is close to any door of the vehicle 200 in accordance with a difference in reception intensity (for example, a distance from each antenna) at each antenna.

The power transmission stand 10 is an electrical device including a communication unit 13, a control unit 14, a transmission unit 15, a cable 16, and a connector 17. For example, the power transmission stand 10 transmits power of the system power supply 400 to the battery 214 of the vehicle 200 to charge the battery 214, or transmits power of the battery 214 to the system power supply 400 to discharge the battery 214.

The communication unit 13 performs wired communication such as power line communication, CAN (Control Area Network) communication, or LAN communication with the ECU 100 of the vehicle 200 via the cable 16 when the connector 17 is connected to the inlet 220 of the vehicle 200. The communication may be performed by wireless communication (for example, Wi-Fi or the like) of various standards.

The control unit 14 controls an operation (for example, a transmission voltage or a transmission current) of the transmission unit 15 based on a control signal received from the ECU 100. The control unit 14 includes a CPU and a memory (both not shown). The control unit 14 controls the transmission unit 15 based on information received from the vehicle 200 using the communication unit 13 and information such as a map and a program stored in the memory.

The transmission unit 15 converts AC power from the system power supply 400 into DC power in accordance with a control signal from the control unit 14, and converts DC power from the battery 214 into AC power. One end of a cable 16 is connected to the transmission unit 15. A connector 17 is connected to the other end of the cable 16.

The connector 17 has a shape attachable to the inlet 220. When the connector 17 is attached to the inlet 220, either the first state in which DC power can be supplied from the transmission unit 15 to the battery 214 or the second state in which AC power can be supplied from the transmission unit 15 to the system power supply 400 is set based on a control signal received by the control unit 14 from the ECU 100. For example, when requesting external charging, the ECU 100 transmits a control signal to the control unit 14 so as to be in the first state when the connector 17 is attached to the inlet 220. For example, when a discharge to the power transmission stand 10 is requested, the ECU 100 transmits a control signal to the control unit 14 so as to be in the second state when the connector 17 is attached to the inlet 220.

For example, when the SOC of the battery 214 is lower than a threshold value, the ECU 100 requests quick charging. In addition, for example, when performing power transmission (hereinafter, referred to as V2H: Vehicle to Home) between the vehicle 200 and a facility (for example, a home) in which the power transmission stand 10 is installed, the ECU 100 requests discharging when the battery 214 is used as a power supply of the facility, and requests charging when surplus power is stored in the battery 214.

The ECU 100 calculates the SOC of the battery 214 and the temperature of the battery 214 using the detection values of the sensors 102, 104, and 106 during power transmission using the battery 214. In the vehicle 200 described above, when the adjustment device 150 (heating device 152 or cooling device 154) is operated to adjust the temperature of the battery 214, operation noise may be generated. Therefore, when the user in the vehicle 200 cannot recognize the cause of the operation sound, the user may feel uncomfortable.

Therefore, in the present embodiment, the display device 110 displays the operation information indicating the state of deviation between the temperature of the battery 214 and the target temperature and the operation state of the adjustment device 150 during the operation of the adjustment device 150.

In this way, the user can recognize the cause of the operation of the adjustment device 150. Therefore, it is possible to prevent the user from feeling uncomfortable even when the adjustment device 150 is operated.

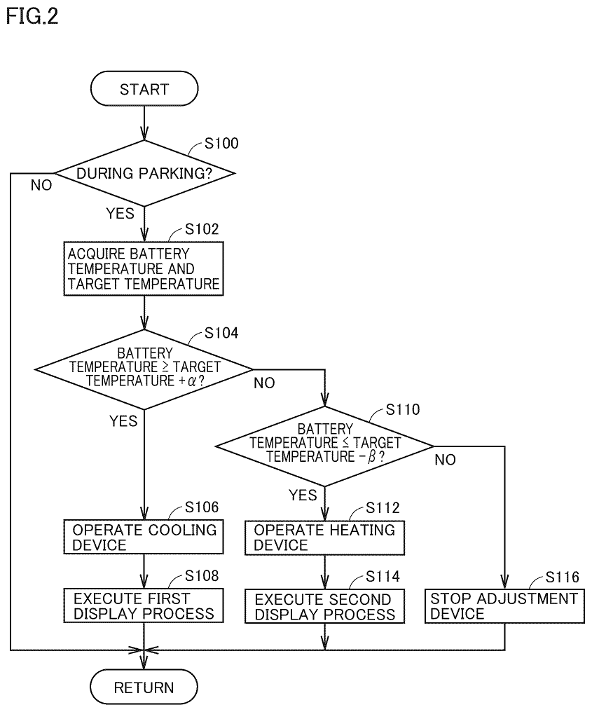

Hereinafter, an example of processing executed by the ECU 100 will be described with reference to FIG. 2. FIG. 2 is a flowchart illustrating an example of processing executed by the ECU 100.

In step 100 (hereinafter, the term “step” will be described as S), the ECU 100 determines whether the vehicle is parked. For example, the ECU 100 may determine that the vehicle is parked when the shift position is the parking position.

Alternatively, the ECU 100 may determine that the vehicle is parked when the vehicle 200 is in a stop state (zero vehicle speed) and the parking brake is in an operation state, for example. Alternatively, the ECU 100 may determine that the vehicle is parked when the connector 17 is attached to the inlet 220. When it is determined that the vehicle is parked (YES in S100), the process proceeds to S102.

In S102, ECU 100 acquires the battery temperature and the target temperature. For example, the ECU 100 acquires the battery temperature using the detection result of the sensor 106. The ECU 100 reads and acquires, for example, a predetermined target temperature from the memory. ECU 100 may set the target temperature according to, for example, the state of vehicle 200, the temperature environment, or the like. For example, the ECU 100 may detect the outside air temperature using an outside air temperature sensor (not shown) and set the target temperature using the detected outside air temperature. Thereafter, the process proceeds to S104.

In S104, ECU 100 determines whether or not the battery temperature is equal to or higher than a value obtained by adding first value a to the target temperature. The first value α is a predetermined value and is set to determine whether or not the battery 214 is in a high temperature state. When it is determined that the battery temperature is equal to or higher than the value obtained by adding the first value α to the target temperature (YES in S104), the process proceeds to S106.

In S106, ECU 100 operates adjustment device 150 (cooling device 154). Thereafter, the process proceeds to S108.

In S108, ECU 100 executes the first display process. The ECU 100 displays, on the display screen of the display device 110, character information indicating that the adjustment device 150 (specifically, the cooling device 154) is in operation and that control is being performed by the operation of the adjustment device 150, and an image indicating a state of deviation between the target temperature and the current battery temperature. Details of display on the display screen of the display device 110 will be described later. Thereafter, the process ends. On the other hand, when it is determined that the battery temperature is lower than the value obtained by adding the first value α to the target temperature (NO in S104), the process proceeds to S110.

In S110, ECU 100 determines whether or not the battery temperature is equal to or less than a value obtained by subtracting second value β from the target temperature. The second value β is a predetermined value and is set to determine whether or not the battery 214 is in a low temperature state. The second value β may be the same as or different from the first value α. When it is determined that the battery temperature is equal to or lower than the value obtained by subtracting the second value β from the target temperature (YES in S110), the process proceeds to S112.

In S112, ECU 100 operates adjustment device 150 (heating device 152). Thereafter, the process proceeds to S114.

In S114, ECU 100 executes the second display process. The ECU 100 displays, on the display screen of the display device 110, character information indicating that the adjustment device 150 (specifically, the heating device 152) is in operation and that control is being performed by the operation of the adjustment device 150, and an image indicating a state of deviation between the target temperature and the current battery temperature. Thereafter, the process ends. On the other hand, when it is determined that the battery temperature is higher than the value obtained by subtracting the second value β from the target temperature (NO in S110), the process proceeds to S116.

In S116, ECU 100 stops the operation of adjustment device 150. When it is determined that the vehicle is not parked (NO in S100), this process is ended.

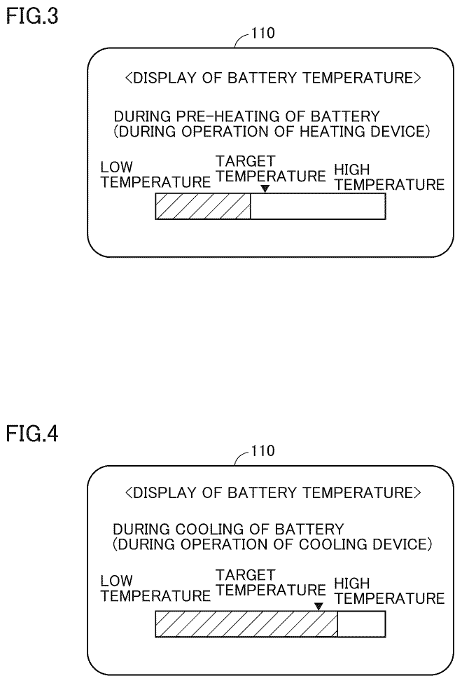

An example of the operation of the ECU 100 based on the above-described structure and flowchart will be described with reference to FIGS. 3 and 4. FIG. 3 is a diagram illustrating an example of a display screen displayed on the display device 110. FIG. 4 is a diagram illustrating another example of a display screen displayed on the display device 110.

When vehicle 200 is parked (YES in S100), ECU 100 acquires the battery temperature and the target temperature (S102), and determines whether or not the battery temperature is equal to or higher than a value obtained by adding first value α to the target temperature (S104).

For example, when the battery temperature is lower than the target temperature +α (NO in S104) and is equal to or lower than the target temperature −β (YES in S110), the heating device 152 enters an operation state (S112). Then, the second display process is executed (S114).

When the second display process is executed, as shown in FIG. 3, on the display screen of the display device 110, character information indicating a display item “DISPLAY OF BATTERY TEMPERATURE” on the upper side of the screen and character information “DURING PRE-HEATING OF BATTERY (DURING OPERATION OF HEATING DEVICE)” on the center of the screen are displayed. The character information includes at least information indicating that the heating device 152 is in operation to increase the temperature of the battery 214.

A band graph in which the lateral direction is the longitudinal direction is displayed below the display position of the character information “DURING PRE-HEATING OF BATTERY (DURING OPERATION OF HEATING DEVICE)”. On the display screen, the character information of “TARGET TEMPERATURE” is arranged in the upper central portion of the band graph, the character information of “LOW TEMPERATURE” is arranged in the upper left portion of the band graph, and the character information of “HIGH TEMPERATURE” is arranged in the upper right portion of the band graph. Further, on the display screen, a triangular mark is arranged at a position between the band graph and the character information of the “TARGET TEMPERATURE” with its vertex facing downward.

In the band graph, a first region from the lower limit value on the low temperature side to the current temperature of the battery 214 is indicated by a hatched region, and a second region from the upper limit value on the high temperature side to the current temperature of the battery 214 is indicated by an unhatched region. That is, the boundary line between the first region with diagonal lines and the second region without diagonal lines indicates the current temperature of the battery 214. In FIG. 3, it is assumed that the current temperature of the battery 214 is lower than the target temperature −β.

Accordingly, the user can recognize, on the display screen, that the current temperature of the battery 214 is lower than the target temperature, that the temperature of the battery 214 is increasing in advance, and that the heating device 152 is operating. Therefore, the user can recognize the cause of the operation of the adjustment device 150 from the information displayed on the display screen.

On the other hand, when the battery temperature is equal to or higher than the target temperature +α (YES in S102), the cooling device 154 is in the operation state (S104). Then, the first display process is executed (S106).

When the first display process is executed, as shown in FIG. 4, on the display screen of the display device 110, character information indicating a display item of “DISPLAY OF BATTERY TEMPERATURE” on the upper side of the screen and character information of “DURING COOLING OF BATTERY (DURING OPERATION OF COOLING DEVICE)” on the center of the screen are displayed. The character information includes at least information indicating that the cooling device 154 is in operation to lower the temperature of the battery 214.

A band graph is displayed below the display position of the character information “DURING COOLING OF BATTERY (DURING OPERATION OF COOLING DEVICE)”. Since the character information and the mark arranged around the band graph are the same as the character information and the mark arranged around the band graph in FIG. 3, detailed description thereof will not be repeated.

Further, since the first region and the second region in the band graph are the same as the first region and the second region in the band graph of FIG. 3, detailed description thereof will not be repeated. In FIG. 4, it is assumed that the current temperature of the battery 214 is higher than the target temperature +α.

Accordingly, the user can recognize, on the display screen, that the current temperature of the battery 214 is higher than the target temperature, that the battery 214 is being cooled, and that the cooling device 154 is being operated. Therefore, the user can recognize the cause of the operation of the adjustment device 150 from the information displayed on the display screen.

As described above, according to vehicle 200 of the present embodiment, since display device 110 displays the operation information indicating the state of deviation between the temperature of battery 214 and the target temperature and the operation state of adjustment device 150 when adjustment device 150 is operated using the power of the external power supply or the power of battery 214, the user can recognize the cause of the operation of adjustment device 150. Therefore, it is possible to prevent the user from feeling uncomfortable even when the adjustment device 150 is operated. Therefore, it is possible to provide a vehicle that displays a state of temperature adjustment of the power storage device so as to be recognizable to the user.

Further, since the display device 110 displays the operation information while the vehicle 200 is parked and the adjustment device 150 is operating, it is possible to allow the user to recognize the cause of the operation of the adjustment device 150 during parking in which the generation of the operation sound is likely to be recognized.

Further, since the display device 110 displays the state of deviation between the target temperature and the current temperature of the battery 214 using the band graph, it is possible to suppress the user from feeling uncomfortable about the operation of the adjustment device 150.

Hereinafter, modifications will be described.

In the above-described embodiment, the first display process or the second display process is performed when the adjustment device 150 is activated while the vehicle 200 is parked, but for example, when the adjustment device 150 is activated while the vehicle 200 is parked and when approach of the terminal 300 to the vehicle 200 is detected, the activation information may be displayed on the display device 110.

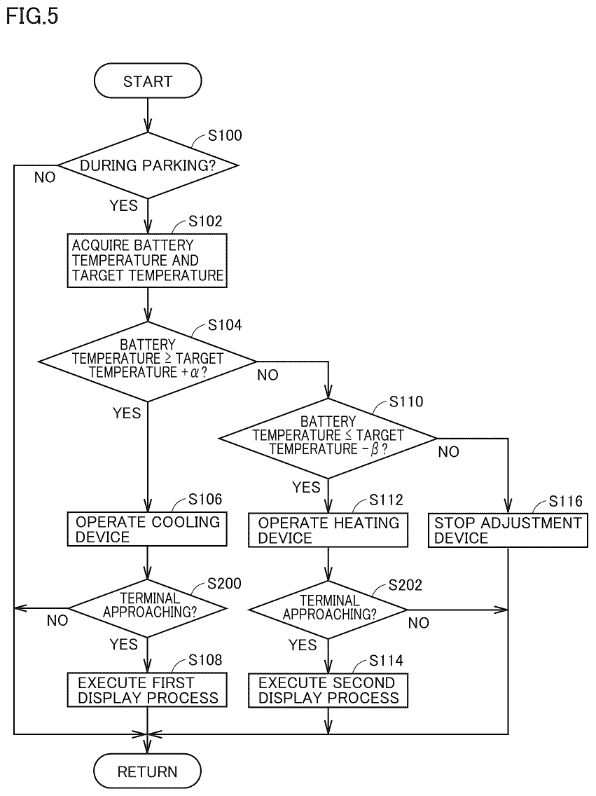

FIG. 5 is a flowchart illustrating an example of processing executed by the ECU 100 according to a modification. Note that the contents of the processing of S100, S102, S104, S106, S108, S110, S112, S114 and S116 of FIG. 5 are respectively the same as the contents of the processing of S100, S102, S104, S106, S108, S110, S112, S114 and S116 of FIG. 2 except for the case described below. Therefore, detailed description thereof will not be repeated.

When the cooling device 154 is brought into the operation state (S106), the process proceeds to S200.

In S200, ECU 100 determines whether or not terminal 300 is approaching vehicle 200. Since the approach detection method is as described above, the detailed description thereof will not be repeated. When it is determined that terminal 300 is approaching vehicle 200 (YES in S200), the process proceeds to S108. When it is determined that terminal 300 is not approaching vehicle 200 (NO in S200), the process ends. On the other hand, when the heating device 152 is brought into the operation state (S112), the process proceeds to S202.

In S202, ECU 100 determines whether or not terminal 300 is approaching vehicle 200. When it is determined that terminal 300 is approaching vehicle 200 (YES in S202), the process proceeds to S114. When it is determined that terminal 300 is not approaching vehicle 200 (NO in S202), the process ends.

In this way, during the operation of heating device 152 or cooling device 154, when terminal 300 approaches vehicle 200 (YES in S200 or YES in S202), the operation information is displayed on the display screen of display device 110 (S108 or S114). Therefore, it is possible to prevent the user carrying the terminal 300 from feeling uncomfortable about the operation of the adjustment device 150.

Further, in the above-described embodiment, the case where the adjustment device 150 is brought into the stop state when the battery temperature is out of the range from the target temperature +α to the target temperature −β has been described as an example, but for example, the ECU 100 may bring the adjustment device 150 into the stop state when the temperature of the battery 214 reaches the target temperature during the operation of the adjustment device 150.

Further, in the above-described embodiment, the case where the state of deviation between the current temperature of the battery 214 and the target temperature is displayed as a band graph has been described as an example, but the state of deviation may be displayed using a circular graph.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A vehicle comprising:
a power storage device that supplies power to a drive source; and
an adjustment device that adjusts a temperature of the power storage device so as to reach a target temperature; and
a display device that displays predetermined information, wherein
during an operation of the adjustment device, the display device displays operation information indicating (i) a state of deviation between the temperature of the power storage device and the target temperature, and (ii) an operation state of the adjustment device.

2. The vehicle according to claim 1, wherein the display device displays the operation information during parking of the vehicle and during an operation of the adjustment device.

3. The vehicle according to claim 2, wherein the display device displays the operation state during the parking of the vehicle and during the operation of the adjustment device, when a terminal that is able to unlock the vehicle is detected to approach the vehicle.

4. The vehicle according to claim 1, wherein the adjustment device adjusts the temperature of the power storage device using the power of the power storage device or power of an external power supply.

5. The vehicle according to claim 4, wherein the display device displays the state of deviation using a band graph or a circular graph.
